(19) United States
(12) Patent Application Publication
(10) Pub. No.: US 2005/0053304 A1
(43) Pub. Date: Mar. 10, 2005

(54) Method and device for the correction of a scanned image

(76) Inventor: Bernhard Frei, Konstanz (DE)

Correspondence Address: SCHIFF HARDIN, LLP;PATENT DEPARTMENT, 6600 SEARS TOWER, CHICAGO, IL, 60606-6473, US

(21) Appl. No.: 10/495,795

(22) PCT Filed: Jul. 10, 2002
(86) PCT No.: PCT/EP02/07702

(30) Foreign Application Priority Data
Nov. 15, 2001 (DE) 10156040.0

(51) Int. Cl. G06T 5/00; G06K 9/42; G06K 9/36

(52) U.S. Cl. 382/257; 382/300; 382/293; 382/286

(57) ABSTRACT

A method and apparatus for correcting a scanned image of a non-planar original that has a constant cross section in one direction, such as a book, provides for applying a coordinate system to the scanned image to align the coordinate system to the direction with the constant cross section. The scanned image is imaged onto a target image, or vise versa, using aspect factors or dilation factors. A single calculation is possible to map an image point from the scanned image to the target image and thereby remove the distortion of the non-planar original.

### BACKGROUND OF THE INVENTION

1. Field of the Invention

The present invention relates generally to a method to correct a scanned image of a non-planar original image that has a constant cross-section contour.

2. Description of the Related Art

In the optical sampling or, respectively, scanning of contoured objects (such as, for example, books), the surface to be scanned is not situated in a single plane. This leads to a distorted image.

This distortion of the image is both disturbing to the human viewer of this image and causes significant problems in automatic methods of evaluating such images.

To correct such images, analytical methods have been known for a long time that calculate the corrected image points from inverse collinearity equations. These collinearity equations are, for example, are shown in chapter 4 of the book “Nahbereichsphotogrammetrie: Grundlagen, Methoden, Anwendungen”, by Thomas Luhmann, Herbert Wichmann Verlag, published 2000, ISBN 3-87907-321-X. To simplify the calculation steps, it is possible that these equations are approximated via polynomials. Furthermore, a network of support points can be defined and then linearly interpolated between these points. All of these operations require floating-point arithmetic. For applications in which the images do not have to be corrected within certain time requirements, this known method is suitable.

A method to scan books comes from European patent document EP 0 744 110 B1 in which the books are placed on a document guidance device, whereby the document guidance device is either fashioned monochrome or is provided with a specific pattern with which the edges of the book situated on the document guidance device can be precisely scanned. The contour or, respectively, the height curve of the book is calculated using the image data hereby determined.

In U.S. Pat. No. 5,416,609, a method is disclosed to scan an opened book whereby the book is scanned by means of a linear optical sensor and this sensor is aligned parallel to the fold of the book. The linear scan region generated by the sensor is moved parallel to the fold of the book over the surface of the book, whereby after each movement step the sensor is focused by means of an optical system. A correction-free image of the book is hereby achieved.

From European patent document EP 1 032 191 A2 comes a method to scan an opened book whereby the image is corrected. For correction, correction values are determined that are added to the coordinates of a scanned image in order to obtain the corrected image. Given such a correction by means of addition, a plurality of calculation steps must be executed. In addition to this, there are image points in the corrected image for which no color values are assigned after the correction. A suitable value must be found for these image points by means of interpolation.

A method originates from European patent document EP 0 720 344 A2 to correct a scanned image of a book. In this method, a dilation factor is used that is dependent only on the x-direction of the coordinate system hereby used. However, this method assumes that the objective or the lens of the scan device is arranged immediately above or in the proximity of the center point of the document. In this method, the book is placed on a guide rail, such that its contour can be projected on the guide rail. The constant cross-section contour of the book is hereby aligned parallel to the x-axis of the coordinate system of the scan device.

A scanner system originates from U.S. Pat. No. 5,835,241 in which a light streak is projected onto the surface to be scanned in order to detect the contour of the surface.

### SUMMARY OF THE INVENTION

The present invention provides a method for automatic correction of a scanned image of a non-planar original with a constant cross-section contour that can be executed very quickly with relatively low calculation effort.

In the inventive method to correct a scanned image of a non-planar original with a cross-section contour that is constant in one direction, the original being scanned with an objective that is stationary, and the scanned image representing a source image that is mapped to a corrected target image with the following steps:
mapping of the source image onto a Cartesian coordinate system, wherein a line of the source image that runs parallel to the constant cross-section contour is arranged parallel to the x-axis,
mapping of the points of the source image Pq(xq,yq) to points of the target image Pz(xz,yz) or vice versa according to the following formula

$$( \begin{matrix}xq \\ yq\end{matrix} ) = ( \begin{matrix}sx \\ sy\end{matrix} ) \cdot ( \begin{matrix}xz \\ yz\end{matrix} ) ,$$
where sx is an x-dilation factor in the x-direction, and sy is a y-dilation factor in the y-direction.

The x-dilation factor and the y-dilation factor, also referred to as extension factors or distortions of the image, depend only on the x-coordinate and not on the y-coordinate, due to the imaging or, respectively, arrangement of the source image in a Cartesian coordinate system in which one line of the source image that runs parallel to the constant cross-section contour is arranged parallel to the x-axis and using an image in which the coordinates are multiplied with corresponding dilation factors. It is hereby possible to respectively calculate a list of x-dilation factors and y-dilation factors that are respectively associated with an x-values, such that only the dilation factors are to be considered dependent on the respective x-value given the calculation of the corrected target image. The dilation factors thus exist as one-dimensional lists and not as multidimensional fields, which significantly reduces the calculation effort, whereby the method can be executed very quickly and very precisely.

### BRIEF DESCRIPTION OF THE DRAWINGS

The present invention is explained in detail hereinbelow with reference to the drawings.

FIG. 1 is a schematic and perspective view of an open book and a scanning device scanning the book via a lens;

FIG. 2A is a schematic illustration of a corrected image of the book;

FIG. 2B is a schematic illustration of the contour of the book from FIG. 2A;

FIG. 3A is a schematic illustration of a corrected image of the image shown in FIG. 2A;

FIG. 3B is a schematic illustration of the contour corresponding to the corrected image;

FIG. 4 is a schematic illustration of the contour of a corrected image of the book to determine the y-dilation factors;

FIG. 5 is a schematic illustration of the contour of a book to determine the x-dilation factors; and

FIG. 6 is a block diagram of a device to execute the mapping of the image points of a target image to the image points of a source image.

### DETAILED DESCRIPTION OF THE PREFERRED EMBODIMENTS

In a particularly advantageous embodiment of the invention, the mapping to the Cartesian coordinate system and the mapping of the points of the source image to the points of the target image or, respectively, vice versa is executed with a single calculation operation. This produces two significant advantages, namely that on the one hand the method can be executed very quickly, and on the other hand rounding errors (which can never be prevented in individual calculation operations) are reduced to a minimum. The method is hereby very precise and at the same time very fast.

In the inventive method for automatic correction of a scanned image of a non-planar original with a cross-section contour constant along one axis, the original is scanned with an objective arranged stationary. The scanned image thereby represents a source image that is mapped to a corrected target image with the following steps:
mapping of the source image onto a Cartesian coordinate system, whereby a line of the source image that runs parallel to the constant cross-section contour is arranged parallel to the x-axis, and the intersection point of the source image with the projection center of the object is placed on the x-acoustic input signal, and
mapping of the points of the source image Pq (xq,yq) to points of the target image Pz (xz,yz) or vice versa according to the following formula

$$( \frac{xq}{yq} ) = ( \frac{sx}{sy} ) \cdot ( \frac{xz}{yz} ) ,$$
where sx is an x-dilation factor in the x-direction, and sy is a y-dilation factor in the y-direction.

The x-dilation factor and the y-dilation factor depend only on the x-coordinate and not on the y-coordinate, due to the mapping or, respectively, arrangement of the source image in a Cartesian coordinate system, in which one line of the source image that runs parallel to the constant cross-section contour is arranged parallel to the x-axis and the intersection point of the source image is placed on the x-axis with the optical axis of the objective. It is hereby possible to respectively calculate a list of x-dilation factors and y-dilation factors that are respectively associated with an x-value, such that only the dilation factors are to be considered dependent on the respective x-value in the calculation of the corrected target image. The dilation factors thus exist as one-dimensional lists and not as multidimensional fields, which significantly reduces the calculation effort, whereby the method can be executed very quickly and very precisely.

The axis along which the cross-section surface is constant can be situated in any arbitrary direction. It in particular is situated within the original, for example as a fold axis in the area of the binding or, respectively, glue backing of a book or a brochure.

An inventively corrected image can be used for continuous automatic processing of the image signals, for example in an image recognition of text recognition system, in an image duplication system, in an archiving system or in any other image or text processing system.

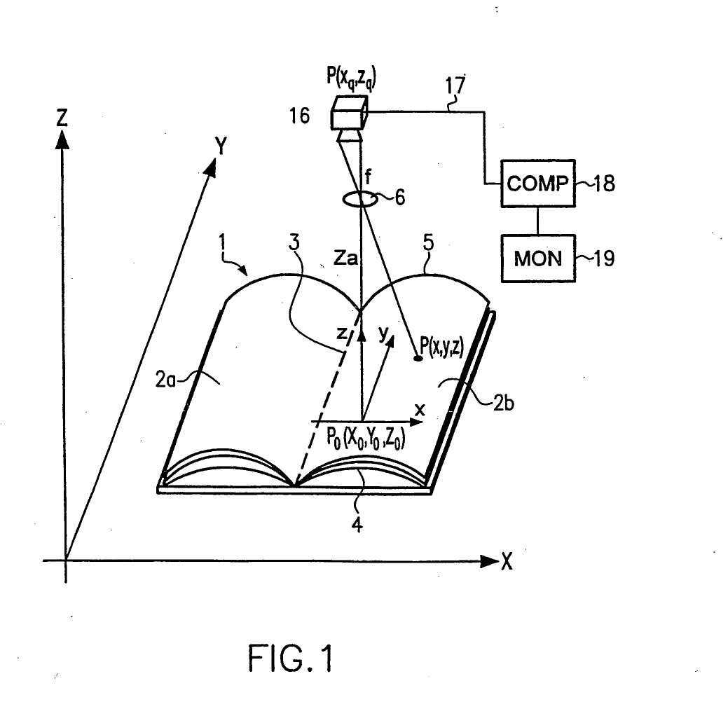

With reference to the figures, the inventive method and apparatus to correct a scanned image of a non-planar original with a constant cross-section contour is explained in detail hereinafter. The invention is subsequently exemplarily shown using a scanned image of an open book. In FIG. 1, an open book 1 exhibits two visible pages 2a and 2b between which a fold 3 is formed. If one slices the book along a plane arranged perpendicular to the fold 3, one obtains a section plane with a specific contour that is independent from the point at which the section plane intersects the fold. This cross-section contour is thus constant from the lower edge 4 to the upper edge 5 of the book, and thus in the direction of the fold 3 or, respectively, along the fold axis. This is significant for the invention, as emerges from the specification stated below. In contrast to this, it is not important for the invention that the contour, as with the book, respectively exhibits a curvature on both sides of the fold 3. The contour can in principle also run in an undulating shape or in a straight line or, for example, exhibit zigzag folds. The inventive correction can thereby be achieved as long as the cross-section contour is constant in an arbitrary direction.

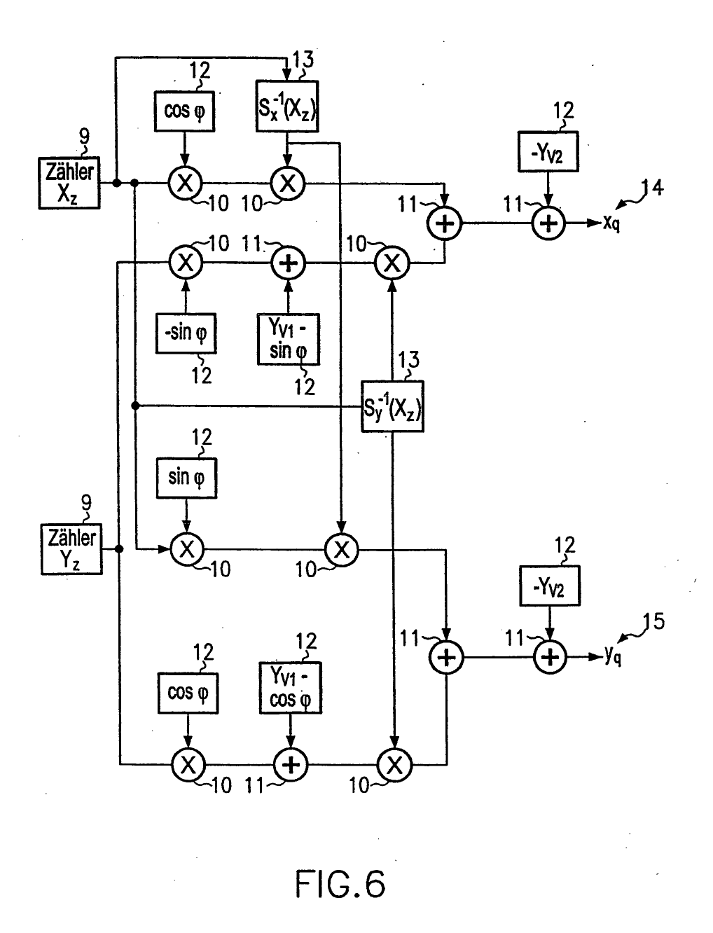

For better understanding of the invention, it is necessary that different coordinate systems are defined. FIG. 1 shows the book 1 and a lens or objective 6, arranged above the book, that schematically shows an objective with a specific focal length f. With this objective 6, the book 1 is mapped to a planar image plane that, for example, is shown via a CCD array 16. Instead of a CCD array, other image acquisition devices or, respectively, cameras can also be used that transduce an optical image into electrical signals. The image signals acquired by the camera 16 are supplied via a signal line 17 to a computer 18 in which the image processing or, respectively, calculation steps to correct the image ensue automatically. For this, in the computer one or more computer programs are loaded which implement the necessary calculations and display the corrected image on a monitor 19. The calculations and displays can, however, also ensue in a corresponding integrated circuit, as is shown in FIG. 6.

In FIG. 1, a Cartesian primary coordinate system is shown with the coordinates X, Y and Z. Furthermore, a second Cartesian global coordinate system is indicated whose origin is arranged at the nadir of the objective 6 on the surface of the book 1, meaning the origin is located at the point of the surface of the book at which the optical axis 7 of the objective 6 intersects the surface of the book. In this global coordinate system, the points are represented by the coordinates x, y and z. The origin P₀ exhibits in the main coordinate system the coordinates X₀, Y₀ and Z₀.

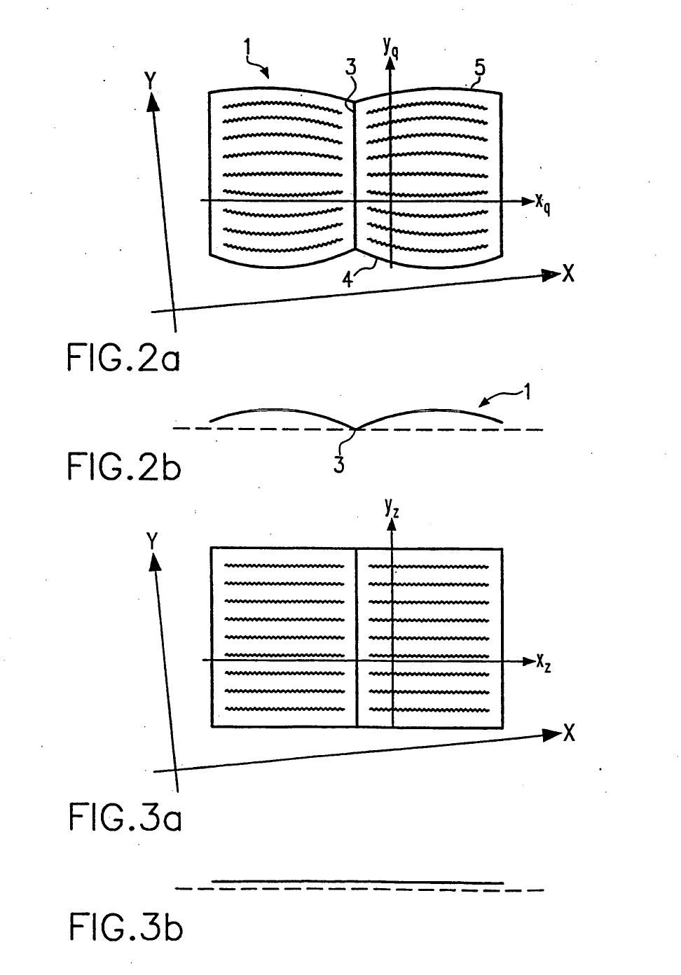

FIG. 2a shows the image obtained from the book 1 in the image plane. Since the portion of the book in the region of the fold is further removed from the objective 6 than in the remaining regions, the region of the fold is distorted relative to the remaining regions.

This image of the book shown in FIG. 2a should be corrected with the invention. The physically acquired image is thereby mapped to a representation of the book in which the sides again possess a rectangular form. The image shown in FIG. 2a is therefore designated as a source image in the following. The corrected representation of the book is shown in FIG. 3a, which is designated as a target image in the following.

The source image is represented in a source coordinate system with the coordinates xq and y_{q}. The target image is correspondingly represented in a target coordinate system with the coordinates x_{z} and y_{z}. The source coordinate system and target coordinate system are respectively arranged with their x-axes parallel to the curve of the contour, whereby the nadir is situated on the x-axis.

FIG. 2b shows the contour of the book that leads to the distortion caused in FIG. 2a. FIG. 3b shows the ideal form of the contour after the correction, namely a straight line.

The X-Y planes of the global coordinate system are respectively indicated in FIGS. 2a and 3a. The global coordinate system can normally be nonlinearly mapped to the source and target coordinate system, meaning that the coordinate axes can be differently scaled.

With the invention, a point of the source image P_{q}(x_{q},y_{q}) should be mapped to a point of the target image P_{z}(x_{z},y_{z}) or vice versa, according to the following formula

$$( \begin{matrix}xq \\ yq\end{matrix} ) = ( \begin{matrix}sx \\ sy\end{matrix} ) \cdot ( \begin{matrix}xz \\ yz\end{matrix} ) , \qquad ( 1 )$$

where sₓ is an x-dilation factor and s_{y} is a y-dilation factor that respectively produce the dilation in the x- or, respectively, y-direction necessary for correction. In conventional methods, both dilation factors sₓ and s_{y} are respectively dependent on x and y, wherefore the calculation of these formulas is extremely complex.

The mapping equation for the y-components of the points of the surface of the book states:

$${y}_{q} = \frac{f ( y + {Y}_{0} )}{f - z - {Z}_{0}} \qquad ( 2 )$$

Since the focal length f is constant, this mapping equation can be formulated as a dilation dependent on z:
y_{q}=s_{y}(z)*(y+Y₀) (3)

By displacing the primary coordinate system in the y-direction by Yᵥ₂=Y₀, Y₀ is placed on the x-axis and thus no longer enters into the dilation. Via this displacement, the intersection point of the source image with the projection centers of the objective is placed on the x-axis. The correction equation then states
y_{q}=s_{y}(z)*y (4)

If the x-axis of the coordinate system is placed parallel to the contour line, this means that the contour of the book, and with it z, can be represented as a function of just x. It is thus possible to write the equation above as follows:
y_{q}=s_{y}(x)*y (5)

In the correspondingly displaced and rotated coordinate system, it is true for each point of the book surface P(x,y,z) and the corresponding point P_{z}(x_{z},y_{z}) that these coincide with regard to their y-coordinates.
y=y_{z}, (6)
where:
   y_{q}=s_{y}(x)*y_{z} (7)

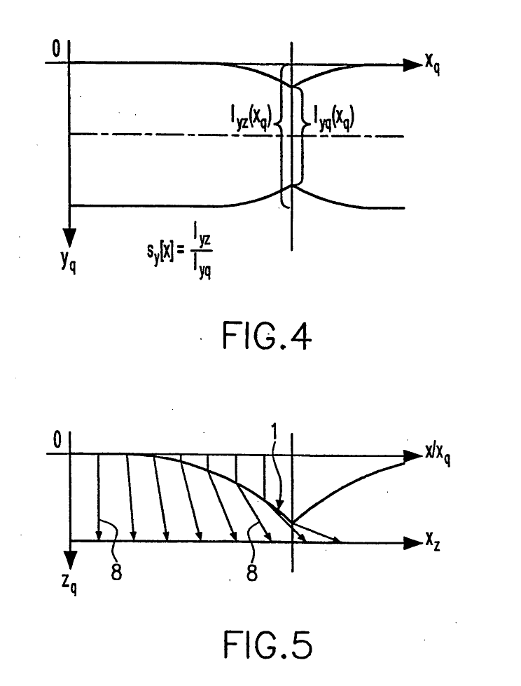

FIG. 4 schematically shows a possible form of the determination of the dilation factor s_{y} using the source image. The separation between the upper edge 5 and the lower edge 4 of the book for the same value x_{q} is designated in the source image as l_{yq}(x_{q}). This separation must be mapped to the corresponding separation l_{yz} that corresponds to the height of the book and is thus independent of x, as one can recognize using FIG. 3. Using the source image, for example, l_{yz} can be determined as the maximal separation between the upper edge and the lower edge of the book. The dilation factor s_{y}(x_{q}) can thus be determined for each value x_{q} using the source image according to the following formula:

$${s}_{y} ( {y}_{q} ) = \frac{{1}_{yz}}{{1}_{yz} ( {x}_{q} )} \qquad ( 8 )$$

For the x-components, the dilation factor sₓ to map the source image to the target image or vice versa is determined according to the following formula:
x_{q}=sₓ*x_{z} (9)

FIG. 5 schematically shows the book in cross-section with its contour, whereby the x-axis and the z-axis are specified by the coordinate system. The x-axis can simultaneously be considered as the x-axis of the source coordinate system when the individual points of the surface of the contour are mapped to the x-axis (x_{q}) perpendicularly. The x-axis (x_{z}) of the target coordinate system is also indicated. In this coordinate system, the spatially curved contour or surface of the book is completely spanned, whereby the individual points of the surface of the book corresponding to the arrows 8 are mapped to the x-axis of the coordinate system. Using FIG. 5, one can well recognize that the image of the surface of the book in the source coordinate system is increasingly strongly distorted in the direction of the fold 3 of the book. This distortion of the book can be compensated by the corresponding dilation with the dilation factor sₓ. In that the contour of the book only changes along the x-axis, the dilation factor sₓ is dependent only on x. The above formula can therefore be represented as follows:
x_{q}=sₓ(x)*x_{z} (10)

Via the skillful selection of the coordinate system, it can thus be achieved that both the x-dilation factor sₓ and the y-dilation factor s_{y} are dependent only on x. For the numerical calculation of the formula (1), this has the significant advantage that, respectively, only one x-dilation factor and one y-dilation factor are to be determined in advance in predetermined intervals along the x-axis, whereby for arbitrary points in the plane of the source image the corresponding association in the target image or, respectively, vice versa is established and can be calculated simply.

For example, the inventive method can be executed with the following steps.

1. Displacement of the Source Image

By means of a mapping, the intersection point of the source image with the optical axis 7 of the objective 6 is displaced onto the x-axis of the coordinate system. This mapping ensues by means of the following displacement matrix:

$$( \begin{matrix}1 & 0 & xv 1 \\ 0 & 1 & yv 1 \\ 0 & 0 & 1\end{matrix} )$$

whereby xv1 is a displacement value in the x-direction and yv1 is a displacement value in the y-direction. Element xv1 corresponds to the distance of the intersection point with the optical axis from the x-axis in the source image not yet displaced. Element yv1 is preferably selected such that it amounts to the separation between this intersection point and the y-axis, whereby the intersection point is displaced onto the origin of the coordinate system.
   2. Rotation of the Displaced Source Image

The displaced source image is rotated by an angle φ, such that a line that runs parallel to the constant cross-section contour of the book is arranged parallel to the x-axis which, for example, is the upper or lower edge of the book. In other words, the displaced source image is rotated such that a line that runs perpendicular to the constant contour (such as, for example, the fold 3) is arranged parallel to the x-axis. This rotation is executed with the following mapping matrix:

$$( \begin{matrix}Cos [ φ ] & Sin [ φ ] & 0 \\ - Sin [ φ ] & Cos [ φ ] & 0 \\ 0 & 0 & 1\end{matrix} )$$

3. Correction

The source image so displaced and rotated is corrected with the following mapping matrix:

$$( \begin{matrix}sx [ xq ] & 0 & 0 \\ 0 & sy [ xq ] & 0 \\ 0 & 0 & 1\end{matrix} )$$

This mapping corresponds to the function (1) explained above.

4. Displacement of the Corrected Image

This corrected image can be displaced such that all points of the image are arranged in one quadrant of the target coordinate system, whereby, for example, the left upper corner is displaced onto the origin of the target coordinate system. This displacement ensues with the following mapping matrix:

$$( \begin{matrix}1 & 0 & xv 2 \\ 0 & 1 & yv 2 \\ 0 & 0 & 1\end{matrix} )$$

whereby xv2 and yv2 are respective displacement values in the x-direction and y-direction. This mapping is optional.

In the numeric conversion of this mapping explained above, the individual points of the source image are sequentially mapped to corresponding points of the target image. For this, an interpolation is necessary upon rotation of the image and upon correction. The interpolation event causes a specific calculation imprecision. In order to keep the calculation imprecision optimally minimal, the four matrices explained above are combined into a single matrix, such that the complete mapping can be executed with a single calculation event and thus with only a single interpolation step per image point. This combined matrix has the following form:

$$( \begin{matrix}cos φ & sin φ \cdot s x & xv 1 + xv 2 \cdot cos φ \cdot sx + yv 2 \cdot sin φ \cdot sx \\ sin φ \cdot sy & cos φ \cdot sy & yv 1 + yv 2 \cdot cos φ \cdot sy - xv 2 \cdot sin φ \cdot sy \\ 0 & 0 & 1\end{matrix} )$$

The calculation precision is significantly raised via this combination of the individual mappings into a single mapping. In addition, the calculation effort is kept very low.

In the preferred embodiment of the inventive method, the image points of the source image are not mapped to the image points of the target image, but rather the image points of the target image are mapped to the image points of the source image. The corresponding image points of the source image are hereby associated with each image point of the target image, which is typically arranged in a specific raster. This image point of the source image can naturally deviate from the image points predetermined by the raster of the source image and be determined via interpolation of the corresponding adjacent image points. For this, the inverse matrix of the combined mapping matrix specified above is determined, possessing the following form:

$$[ \begin{matrix}\frac{cos φ}{sx} & - \frac{sin φ}{sy} & - xv2 - \frac{xv1 \cdot cos φ}{sx} + \frac{yv1 \cdot sin φ}{sy} \\ \frac{sin φ}{sx} & \frac{cos φ}{sy} & - yv2 - \frac{yv1 \cdot sin φ}{sx} + \frac{yz1 \cdot cos φ}{sy} \\ 0 & 0 & 1\end{matrix} ]$$

To map a point of the target image Pz (xz, yz, 0), this is multiplied with the mapping matrix, whereby the coordinates of the corresponding image point Py (xq, yq, 0) in the source image are obtained. The color saturation values (when it is a color image) or the grey scales (when it is a black-and-white image) are subsequently calculated for this image point of the source image via interpolation of the corresponding color saturation values or, respectively, grey scales of the adjacent image points. These calculated color values or, respectively, color valences (color saturation values or, respectively, grey scales) are associated with the image point of the target image with the coordinates xz and yz. This calculation is executed for each image point of the target image, such that the target image can be assembled pixel-by-pixel based on the data of the source image. The dilation factors sx and sy are hereby respectively selected from the lists calculated beforehand, dependent on the x-coordinates xz of the image point Pz of the target image.

It is already explained above using FIG. 4 how the dilation factors sy can be determined using the source image in the source coordinate system.

For the determination of the x-dilation factors, it is appropriate that the curve of the contour of the book is first determined. By eliminating yq by combining both formulas (2) and (7) specified above and solving for z(x), the following formula results:

$$z ( x ) - ZO + f - \frac{f ( y + YO )}{y} \cdot sy ( x ) \qquad ( 11 )$$

This formula is specified as a y-dilation factor sy that has already been calculated in the source coordinate system. The individual values respectively valid for one xq can be associated from sy with the corresponding x-values x in the image coordinate system by means of the optical mapping function. Values for y and yz are also to be used in this function. It is hereby to be considered that the values of y and yz respectively refer to an image point in the image coordinate system or, respectively, in the source coordinate system that are optically mapped to one another. One preferably, respectively takes the values y and yz from corresponding points at the edge of the book. The remaining parameters (f, Z0, Y0) are known. The contour of the book can thus be calculated in the image coordinate system.

After obtaining a function describing the contour of the book, the length of the surface of the contour along the surface can be calculated. This can, for example, be executed by dividing the contour into small segments whose lengths AS are individually calculated according to the following formula:
ΔS(Xₙ, Xₙ₊₁)=\sqrt{(Xₙ−Xₙ₊₁)²+(Yₙ−Yₙ₊₁)²} (12)
These individual segments can be summed into a length lxᵢ.

$${1}_{xi} = {\sum }_{{x}_{0}}^{{x}_{i}} Δ S \qquad ( 13 )$$

The dilation factor sx is the quotient from the summed length divided by the corresponding length along the x-axis. If one begins the summation at x₀=0, the x-dilation factor can be represented as follows:

$${S}_{x} = \frac{1 {x}_{i}}{{x}_{i}} \qquad ( 14 )$$

One has thus determined the x-dilation factors in the global coordinate system. This can be translated to the source coordinate system, such that both the x-dilation factor and the y-dilation factor exist for each value of xq in the source coordinate system. The image points of the source image can be mapped to the image points of the target image with these dilation factors. The inverse mapping can naturally also be formed.

Different methods to determine the contour of a scanned, contoured subject matter are known. In the framework of the invention, it is naturally also possible to use other methods to calculate the contour or to physically measure the contour, and to calculate the dilation factor in a correspondingly different manner. It is significant for the invention that, respectively only one one-dimensional list of x-dilation factors and of y-dilation factors is necessary to calculate the mappings of the image points of the source image to the target image and vice versa.

By the term “dilation”, what is also to be understood is a dilation with negative dilation factors, which can also be designated as a compression.

FIG. 6 shows a block diagram of a device to execute the mapping of the image points of the target image to the respective image points of the source image. This device comprises a first and a second counter 9 by which the image points of the target image are counted in the x-direction or, respectively, y-direction. These counters 9 are circuited with a plurality of multipliers 10 and adders 11 and some registers 12 and two lists 13 to execute the mapping represented above by the combined inverse mapping matrix. The values for cos φ, −sinφ, yv1−sin φ, sin φ, −yv1−cos φ, −xv2 and −yv2 are stored in the registers 12. The angle φ can, for example, be measured as the angle between a terminating edge of the book and a terminating edge of the entire scanned surface (which is normally rectangular). The intersection point of the geometric axis of the objective with the source image is determined by the arrangement of the objective relative to the entire area to the mapped, such that the corresponding intersection point can be simply determined in the source image. The displacement parameters xv1, yv1, xv2 and yv2 can be simply determined from this. These parameters are stored in the registers 12 in the manner shown in FIG. 6. The scanned image is subsequently rotated to determine the dilation factors. The dilation factors are stored in the corresponding lists 13.

The size of the target image is set by the number of the image points in the x-direction and y-direction of the target image (for example, 1000×1000 pixels). The individual image points of the target image are subsequently enumerated by means of the counters 9 and 10, and the coordinates of the corresponding image points of the source image are respectively output to the outputs 14 and 15. The color valences of the image points of the source image are then determined and associated with the corresponding image points of the target image. A corrected target image is hereby generated from the distorted source image.

The individual multipliers 10 and adders 11 can be fashioned as integer operators. The value ranges of the lists are normally in the range of 0.5 to 1.5. Given such value ranges, it is sufficient that the parameters and dilation factors are stored as 16-digit binary numbers (16-bit), whereby a spatial precision is achieved in the thousandth-range without requiring the use of a floating-point arithmetic.

An image freed from dilation, or extension, is automatically generated in the inventive mapping event via the use of the displacement parameters xv2 and yv2.

Since the rotation, correction and scaling events are executed in one mathematical operation, a significant increase of the precision is also achieved in addition to the significant savings in hardware resources or, respectively, calculation runtime.

The device shown in FIG. 6 can again be reduced in various clock phases given the multiple use of the adders and multipliers.

The invention can be briefly summarized as follows:

The invention concerns a method to correct a scanned image of a non-planar object with a constant cross-section contour, such as, for example, a book. The invention also concerns a device to execute the method and software to carry out the method.

The dilation factors sx and sy to map the image points of the source image to the target image or, respectively, vice versa are dependent only on the x-direction, due to the rotation and displacement of the scanned source image in a coordinate system such that the constant cross-section contour is arranged parallel to the x-axis. The calculation of the mapping is hereby significantly simplified.

Inventive devices can be fashioned as a circuit, as a computer, and as a computer program that effect an inventive method cycle upon loading and execution on a computer. Corresponding computer program products such as, for example, storage elements (diskettes, CD-ROMs, RAMs, etc.) are therefore also within the spectrum of the present invention. An inventive device can also be integrated into a larger overall system, for example into a document reproduction system with a scanner that automatically scans objects, an image processing device to process the scanned image signals, and a print device for single or multiple duplication of the document, or an archive storage in which the scanned documents are electronically stored.

Although other modifications and changes may be suggested by those skilled in the art, it is the intention of the inventors to embody within the patent warranted hereon all changes and modifications as reasonably and properly come within the scope of their contribution to the art.

1-13. (Cancelled).

14. A method to correct a scanned image of a non-planar original that has a constant cross-section contour in one direction, the non-planar original being scanned by a stationary objective to provide a scanned image as a source image, comprising the steps of:
mapping the source image to a Cartesian coordinate system, said mapping including arranging one line of the source image that runs parallel to the constant cross-section contour parallel to an x-axis; and
mapping points of the source image Pq(xq,yq) to points of the target image Pz(xz,yz) or vice versa according to a formula
$$( \begin{matrix}xq \\ yq\end{matrix} ) = ( \begin{matrix}sx \\ sy\end{matrix} ) \cdot ( \begin{matrix}xz \\ yz\end{matrix} ) ,$$
wherein sx is an x-dilation factor in an x-direction and sy is a y-dilation factor in a y-direction.

15. A method according to claim 14, further comprising the steps of:
positioning an intersection point of the source image with an optical axis of the objective on the x-axis in said step of mapping of the source image.

16. A method according to claim 14, wherein said object to be scanned is an opened book.

17. A method according to claim 14, wherein said mapping of the source image step includes mapping the source image with its left edge on a y-axis in said step of mapping of the source image to the Cartesian coordinate system.

18. A method according to claim 14, further comprising the steps of:
dividing the source image and the target image into pixels that are arranged in columns running parallel to a y-axis and rows running parallel to the x-axis; and
storing one x-dilation factor and one y-dilation factor for each column.

19. A method according to claim 18, further comprising the steps of:
mapping pixels of the target image to points of the source image;
interpolating image points of the source image to respective points so that color saturation of the respective points of the source image ensues; and
transferring of the color saturation to the image points of the target image.

20. A method according to claim 14, further comprising the step of:
executing said mapping step to the Cartesian coordinate system and said mapping step of the points of the source image to the points of the target image or vice versa with a single calculation operation.

21. A method according to claim 20, wherein said step of mapping of the points of the source image the points of the target image ensues via multiplication of the points of the source image with the following matrix
$$( \begin{matrix}cos φ & sin φ \cdot sx & xv1 + xv2 \cdot cos φ \cdot sx + yv2 \cdot sin φ \cdot sx \\ sin φ \cdot sy & cos φ \cdot sy & yv1 + yv2 \cdot cos φ \cdot sy - xv2 \cdot sin φ \cdot sy \\ 0 & 0 & 1\end{matrix} ) ,$$
where xv1 and yv1 are displacement parameters to displace the source image with the projection center of the objective on the x-axis, φ is the angle by which the source image must be rotated so that its fold runs parallel to the y-axis, xv2 and yv2 are displacement parameters to displace the rotated image by a predetermined vector.

22. A method according to claim 20, wherein said steps of mapping of the points of the target image to the points of the source image ensues via multiplication of the points of the target image with the following matrix
$$[ \begin{matrix}\frac{cos φ}{sx} & - \frac{sin φ}{sy} & - xv2 - \frac{xv1 \cdot cos φ}{sx} + \frac{yv1 \cdot sin φ}{sy} \\ \frac{sin φ}{sx} & \frac{cos φ}{sy} & - yv2 - \frac{yv1 \cdot sin φ}{sx} + \frac{yz1 \cdot cos φ}{sy} \\ 0 & 0 & 1\end{matrix} ] ,$$
where xv1 and yv1 are displacement parameters to displace the source image with the projection center of the objective on the x-axis, φ is the angle by which the source image must be rotated so that its fold runs parallel to the y-axis, xv2 and yv2 are displacement parameters to displace the rotated image by a predetermined vector.

23. A method according to claim 14, wherein the x-dilation factors and y-dilation factors are integer numbers with a precision of at least 16 bits.

24. A device to correct a scanned image of a non-planar original with a constant cross-section contour in one direction, a source image being mapped to a Cartesian coordinate system with one line of a source image running parallel to the constant cross-section contour being arranged parallel to an x-axis of the Cartesian coordinate system, and points of the source image being mapped to points of a target image or vise versa according to a formula
$$( \begin{matrix}xq \\ yq\end{matrix} ) = ( \begin{matrix}sx \\ sy\end{matrix} ) \cdot ( \begin{matrix}xz \\ yz\end{matrix} ) ,$$
wherein sx is an x-dilation factor in an x-direction and sy is a y-dilation factor in a y-direction, comprising:
a counter to count the columns of the target image;
a counter to count the rows of the target image;
a storage device to store dilation factors, parameters and values of cos φ and sin φ;
a plurality of adder devices and multiplier devices that are connected such that corresponding coordinates of the source image are output dependent on the respective state of both said counters.

25. A device according to claim 24, wherein said plurality of the adder devices and multiplier devices are fashioned to only execute whole-number calculation operations.

26. A computer program product to execute a method to correct a scanned image of a non-planar original with a constant cross-section contour in one direction, comprising the steps of:
arranging the non-planar object to be scanned to be stationary;
scanning the non-planar object to provide a scanned image;
mapping the source image to a Cartesian coordinate system, said mapping including arranging one line of the source image that runs parallel to the constant cross-section contour parallel to an x-axis; and
mapping points of the source image Pq(xq,yq) to points of the target image Pz(xz,yz) or vice versa according to a formula
$$( \begin{matrix}xq \\ yq\end{matrix} ) = ( \begin{matrix}sx \\ sy\end{matrix} ) \cdot ( \begin{matrix}xz \\ yz\end{matrix} ) ,$$
wherein sx is an x-dilation factor in an x-direction and sy is a y-dilation factor in a y-direction.
